(19) United States
(12) Patent Application Publication
(10) Pub. No.: US 2026/0141788 A1
(43) Pub. Date: May 21, 2026

(54) SECURE DIGITALIZATION OF DATA TRADITIONALLY STORED ON DIGITAL VERSATILE DISCS

(71) Applicant: Brightstar Global Solutions Corporation, Providence, RI (US)

(72) Inventors: Veniero Merlini, Rome (IT); Gianluca Ragnoni, Rome (IT); Emanuele Martire, Rome (IT); Aniello Raviele, Rome (IT)

(21) Appl. No.: 18/950,910

(22) Filed: Nov. 18, 2024

(51) Int. Cl. G07F 17/32

(52) U.S. Cl. CPC G07F 17/329

(57) ABSTRACT

Systems and methods that enable the secure digitalization of data traditionally stored on digital versatile discs, and in various embodiments, relates to the systems and methods that enable the secure digitalization of draw lottery ticket data traditionally stored on digital versatile discs and that can be employed for draw lottery ticket selling and redemption systems.

### BACKGROUND

The present disclosure relates to secure digitalization of data traditionally stored on digital versatile discs (“DVDs”) such as for draw lottery ticket selling and redemption systems.

Draw lottery ticket selling and redemption systems enable players to purchase draw lottery tickets for a play of a draw lottery game. These draw lottery ticket selling and redemption systems physically maintain data regarding such draw lottery tickets on DVDs to enable redemption of such draw lottery tickets that are winning draw lottery tickets.

### BRIEF SUMMARY

In various embodiments, the present disclosure relates to a lottery ticket selling and redemption system including a central system comprising a processor and a memory device that stores a plurality of instructions. When executed by the processor, the instructions cause the central system to: receive draw lottery ticket data for draw lottery tickets associated with a play of a draw lottery game; generate a digital fingerprint based on the draw lottery ticket data; and employ a plurality of separate security keys to encrypt the draw lottery ticket data with an enveloping function, wherein access to the plurality of separate security keys is controlled by a plurality of separate users and access to the draw lottery ticket data is controlled by the plurality of separate security keys, and data integrity of the draw lottery ticket data is verifiable using the digital fingerprint.

In various other embodiments, the present disclosure relates to a lottery ticket selling and redemption system including a central system comprising a processor and a memory device that stores a plurality of instructions. When executed by the processor, the instructions cause the central system to employ a plurality of separate security keys to decrypt an encrypted disc image to generate a candidate disc image associated with draw lottery ticket data. The encrypted disc image comprises an encrypted intermediate file that was encrypted with a second security key of the plurality of separate security keys. the encrypted intermediate file comprises the candidate disc image that was encrypted with a first security key of the plurality of separate security keys. access to the plurality of separate security keys is controlled by a plurality of separate users. Access to the candidate disc image is controlled by the plurality of separate security keys. When executed by the processor, the instructions cause the central system to employ a first digital fingerprint of an original disc image associated with the draw lottery ticket data and a second digital fingerprint of the candidate disc image to verify data integrity of the candidate disc image.

In various other embodiments, the present disclosure relates to a lottery ticket selling and redemption system including a central system comprising a processor and a memory device that stores a plurality of instructions. When executed by the processor, the instructions cause the central system to: receive draw lottery ticket data for draw lottery tickets associated with a play of a draw lottery game; generate a first digital fingerprint based on the draw lottery ticket data; employ a plurality of separate security keys to encrypt the draw lottery ticket data with an enveloping function to generate an encrypted disc image, wherein access to the plurality of separate security keys is controlled by a plurality of separate users and access to the draw lottery ticket data is controlled by the plurality of separate security keys, and data integrity of the draw lottery ticket data is verifiable using the first digital fingerprint; sequentially decrypt the encrypted disc image using each of the plurality of separate security keys to generate a decrypted disc image; generate a second digital fingerprint based on the decrypted disc image; and employ the first digital fingerprint and the second digital fingerprint to verify data integrity of the decrypted disc image.

Additional features are described in, and will be apparent from, the following Detailed Description and the figures.

### BRIEF DESCRIPTION OF THE SEVERAL VIEWS OF THE DRAWINGS

FIG. 1 is front view of an example draw lottery ticket for a draw lottery game.

FIG. 2 is a diagrammatic view of a lottery ticket selling and redemption system configured to create and store draw lottery ticket data and provide access to such draw lottery ticket data to enable redemption of winning draw lottery tickets.

FIG. 3 is a diagrammatic view of the lottery ticket selling and redemption systems in accordance with the example embodiment of the present disclosure.

FIG. 4 is a block diagram of the lottery ticket selling and redemption system and features provided by the lottery ticket selling and redemption systemin accordance with the example embodiment of the present disclosure.

FIG. 5 is a flow diagram showing one example method of operating the lottery ticket selling and redemption system to enable the redemption of draw lottery tickets in accordance with one example embodiment of the present disclosure.

### DETAILED DESCRIPTION

In various embodiments, the present disclosure relates to systems and methods that enable the secure digitalization of data traditionally stored on digital versatile discs (“DVDs”).

In various embodiments, the present disclosure relates to the systems and methods that enable the secure digitalization of draw lottery ticket data traditionally stored on DVDs and that can be employed for draw lottery ticket selling and redemption systems.

In various embodiments, the present disclosure relates to draw lottery ticket selling and redemption systems that provide the secure digitalization of draw lottery ticket data for draw lottery tickets for draw lottery ticket games and eliminates the need for the creation, storage, and use of DVDs that store the draw lottery ticket data.

While lottery ticket selling and redemption systems are used as the primary example to explain various embodiments of the systems and methods providing the secure digitalization of data traditionally stored on DVDs, such examples are not meant to limit the present disclosure.

For a better understanding of the present disclosure, an example draw lottery ticket is first described herein.

A draw lottery ticket can include: (1) a single set of player numbers for a single play of a draw lottery game; (2) multiple sets of player numbers for a single play of a draw lottery game; (3) a single set of player numbers for each of multiple plays of a draw lottery game; or (4) multiple sets of player numbers for each of multiple plays of a draw lottery game. For simplicity, the present disclosure uses a draw lottery ticket with a single set of player numbers for a single play of a draw lottery game as an example, but it should be appreciated that the present disclosure can be employed for purchasing and redeeming such various other draw lottery tickets.

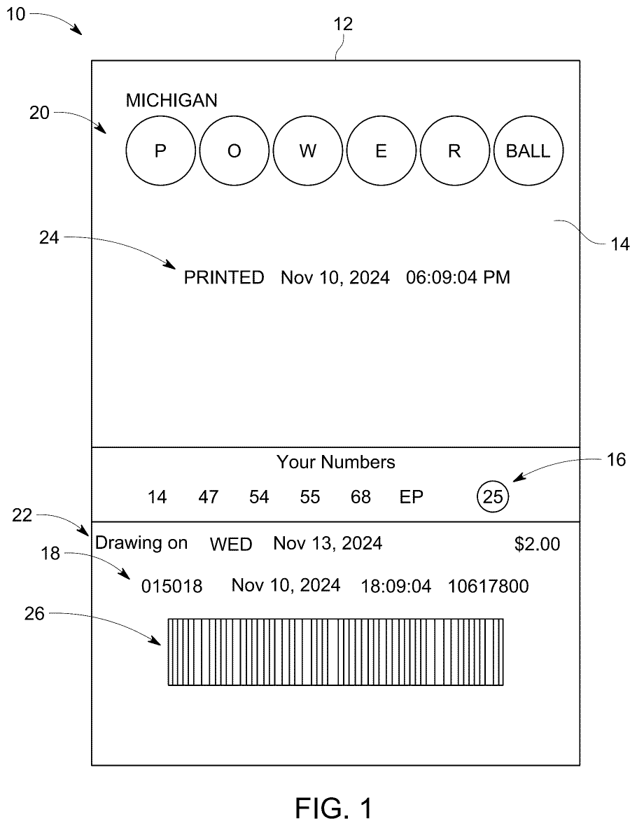

An example physical draw lottery ticket 10 is shown in FIG. 1. This example draw lottery ticket 10 is for a single play of a draw lottery game and includes: (1) a ticket substrate 12; (2) a front surface 14 of the ticket substrate 12; (3) lottery ticket information including a single set of player numbers 16 for a single play of the draw lottery game) printed on the front surface 14 of the ticket substrate 12; and (4) a back surface (not shown) of the ticket substrate 12. This example draw lottery ticket 10 is for a single play of a draw lottery game scheduled to take place on Nov. 10, 2024, and includes a single set of player numbers 16 for the single play of the draw lottery game. The lottery ticket information in this example includes player numbers 16, a draw lottery ticket identifier 18 that uniquely identifies the draw lottery ticket 10, a draw game identifier 20 that identifies the draw lottery game, a draw date 22 for the play of the draw lottery game, and a print date 24 on which the draw lottery ticket 10 was printed. The lottery ticket information can include text, a draw lottery ticket number (which is the ticket identifier 18, a draw lottery ticket barcode 26, and other lottery ticket information that is in either or both human readable and machine readable forms. The lottery ticket barcode 26 is configured to be scanned by a barcode reading device to enable identification and redemption of the draw lottery ticket 10 if the draw lottery ticket 10 is a winning draw lottery ticket.

Additionally, for a better understanding of the present disclosure, various known systems and methods employed for purchasing draw lottery tickets are also now described.

In a first example known draw lottery ticket system and method for purchasing a draw lottery ticket for a draw lottery game in person, a player selects the player numbers for the draw lottery ticket and the player fills out a paper play slip with the player's selected numbers. The player hands that play slip to an operator of a lottery terminal and the operator causes the operator uses a lottery terminal including a contact image sensor (CIS) reader to scan the paper play slip. The CIS reader of the lottery terminal creates play slip scan data for the play of the draw lottery game. The CIS reader provides the play slip scan data to the terminal application of the lottery terminal. The terminal application of the lottery terminal interprets and uses that play slip scan data to create a draw lottery ticket including the player numbers and other information described above. The lottery terminal and specifically the terminal application causes a lottery ticket printer to print out the draw lottery ticket. The lottery ticket printer can be part of the lottery terminal or separate from but connected to the lottery terminal. The operator of the lottery terminal also collects the payment for the draw lottery ticket and provides the printed draw lottery ticket to the player. The lottery terminal can include the CIS reader and the lottery ticket printer in one cabinet. The CIS reader and/or the lottery ticket printer can be separate from the lottery terminal cabinet and connected to the lottery terminal by suitable wires.

In one variation of this example known method for purchasing a draw lottery ticket for a draw lottery game in person, a player does not select the player numbers for the draw lottery ticket and the player marks a paper play slip with an indication of a requested quick pick for the player numbers. The player hands that play slip to an operator of a lottery terminal and the operator uses a lottery terminal including a CIS reader to scan the paper play slip. The CIS reader of the lottery terminal creates play slip scan data for the play of the draw lottery game. The CIS reader provides the play slip scan data to the terminal application of the lottery terminal. The terminal application of the lottery terminal interprets and uses that play slip scan data to create a draw lottery ticket including the player numbers and other information described above. In this case, the lottery terminal randomly generates the player numbers. The lottery terminal causes a lottery ticket printer to print out the draw lottery ticket.

In another variation of this method for purchasing a draw lottery ticket for a draw lottery game in person, a player does not fill out a paper play slip with the player's selected numbers, but rather the player tells the operator of a lottery terminal that the player wants to purchase a draw lottery ticket using a quick pick for a draw lottery game and the operator inputs that request into the lottery terminal (via an operator interface of the lottery terminal). The lottery terminal randomly determines the player numbers for the player's lottery ticket for the play of the lottery game and uses those numbers to create a draw lottery ticket. The lottery terminal then causes a lottery ticket printer to print out the draw lottery ticket.

In another variation of this method for purchasing a draw lottery ticket for a draw lottery game in person, a player uses a suitable application on a player's computer such as a player smartphone to fill out an electronic play slip displayed by the player's smartphone with the player's selected numbers for the draw lottery game or a quick pick. The application on the player's smartphone creates a barcode displayable by the display device of the player mobile electronic device. The player causes their mobile electronic device to display the barcode such that a CIS reader of a lottery terminal having a barcode scanner scans the barcode and creates player slip scan data representing the player numbers or the quick pick for the play of the draw lottery game. The CIS reader sends the player slip scan data to a terminal application of the lottery terminal, and the terminal application uses that player slip scan data to create a draw lottery ticket including the player numbers (respectively either selected by the player or randomly selected by the lottery terminal). The lottery terminal causes a lottery ticket printer to print out the draw lottery ticket.

In each of these variations, the lottery terminal sends data regarding each purchased draw lottery ticket for each draw lottery game to a central lottery server of the draw lottery selling and redemption system. This draw lottery ticket data includes: (1) the player numbers for the draw lottery ticket; (2) the draw lottery ticket identifier that uniquely identifies the draw lottery ticket 10; (3) the draw game identifier that identifies the draw lottery game; (4) the draw date for the play of the draw lottery game; (5) a print date on which the draw lottery ticket was printed; (6) bar code related data for the draw lottery ticket; and/or (7) an amount played.

For certain known draw lottery ticket selling and redemption systems (referred to as “draw lottery ticket systems”), and particularly for certain validation and verification procedures, the draw lottery ticket system creates a series of physical DVDs for each draw lottery game. The physical DVDs store all of the draw lottery ticket data for each and every draw lottery ticket purchased for such draw lottery game (regardless of the purchase method) and before the draw occurs for that draw lottery game. When creating each physical digital versatile disc (“DVD”), a computer is employed to create a disc image for that physical DVD. The disc image can include data to be recorded onto the physical DVD, a read-only file system, and/or other suitable data or metadata. In this example using DVDs, the disc image corresponds to optical media (i.e., the physical DVD) and the read-only file system is based on the International Organization for Standardization (ISO) 9660 standard. Disc images based on the ISO 9660 standard are often referred to as “ISO images” or simply “ISOs.”

The creation and storage of these physical DVDs is managed and controlled by a committee of people such as three people who include regulators and two operators (that are sometimes called concessionaries). The committee physically oversees the creation of the physical DVDs for the draw lottery game, the handling of the physical DVDs, and the storage of the physical DVDs in a safe prior to the time the draw for that draw lottery game occurs. Each committee member has a physical key for the safe that stores the DVDs.

After the draw occurs for the draw lottery game, and thus after the drawn winning numbers are known, the committee uses their respective keys to open the safe and to remove the physical DVDs from the safe. The committee then inserts the physical DVDs (one by one) into a stand alone personal computer (that includes a DVD reader) to obtain all of the draw lottery ticket data for the play of the draw lottery game from the physical DVDs. The physical DVDs are then returned to the safe in case they are needed later for resolving any draw lottery ticket disputes.

The personal computer performs part of a verification process. The verification process includes the personal computer determining every single winning draw lottery ticket based on the drawn winning numbers and the draw lottery ticket data for the play of the draw lottery game. The verification process includes creating winning draw lottery ticket data.

This winning draw lottery ticket data is transmitted to the draw lottery ticket system and particularly the central lottery server of the draw lottery ticket system. This winning draw lottery ticket data is subsequently employed by the central lottery server of the draw lottery ticket system to verify that each draw lottery ticket for the draw lottery game that is attempted to be redeemed by any draw lottery ticket holder is an actual winning draw lottery ticket for that draw lottery game.

For example, when a person tries to redeem a draw lottery ticket via a lottery ticket terminal, the lottery ticket terminal reads a lottery ticket identification number (such as the draw lottery ticket identifier 18) and/or the barcode (such as the draw lottery ticket barcode 26) and creates and sends a request to the central lottery server of the draw lottery ticket system to verify that the identified draw lottery ticket is a valid winning lottery ticket and the award amount. The request includes the lottery ticket identification number. The central lottery server uses the winning draw lottery ticket data and the request data to determine if the draw lottery ticket is a winning draw lottery ticket and if so the award amount.

If the central lottery server of the draw lottery ticket system verifies that the draw lottery ticket is a winning draw lottery ticket and the award amount is below a threshold, the central lottery server of the draw lottery ticket system sends a payment approval back to the lottery terminal. The operator of the lottery terminal can then pay the player the award amount.

If the central lottery server of the draw lottery ticket system verifies that the lottery ticket is a winning lottery ticket and the award amount is at or above a threshold, the central lottery sever of the draw lottery ticket system sends a notification back to the lottery terminal such that the lottery terminal or the operator thereof can inform the player that the player must redeem the draw lottery ticket in person at a lottery office.

If the central lottery server of the draw lottery system determines that the lottery ticket is not a winning draw lottery ticket, the central lottery server of the lottery system sends a payment denial to the lottery terminal and informs (or enables an operator thereof to inform) the player that the draw lottery ticket is not a winning draw lottery ticket. The player can take further action at the lottery office if the player still believes that the draw lottery ticket is a winning draw lottery ticket.

For various draw lottery ticket systems, each of the physical DVDs is created in duplicate to ensure accuracy and no loss of the data on the physical DVDs.

For various draw lottery ticket systems, thousands of physical DVDs are generated and stored every year. The production, safe storage, and handling of such large quantities of physical DVDs requires a substantial amount of physical DVDs, substantial human resources, and substantial storage space for storing the physical DVDs for a predetermined period of time after the drawing for the draw lottery game.

Various embodiments of the present disclosure provide draw lottery ticket selling and redemption systems and methods that enable the purchase of draw lottery tickets and that digitalize the draw lottery ticket data for such draw lottery tickets (that would previously be stored on such physical DVDs) while providing at least the same level of security and access to the winning draw lottery ticket data for central lottery systems of the draw lottery ticket selling and redemption system.

The draw lottery ticket selling and redemption system and method of the present disclosure guarantees integrity, non-reputability, and confidentiality of the draw lottery ticket data for the draw lottery game.

The draw lottery ticket selling and redemption system and method of the present disclosure also eliminates the need for the physical DVDs, the handling of the physical DVDs, and storage of the physical DVDs.

In various embodiments, the present disclosure provides a draw lottery ticket selling and redemption system that includes: (1) a draw lottery ticket data creation and storage system; and (2) a draw lottery ticket data access and validation system.

In various embodiments, the draw lottery ticket data creation and storage system and the draw lottery ticket data access and validation system are completely separate. In various other embodiments, the draw lottery ticket data creation and storage system and the draw lottery ticket data access and validation system includes one or more components that are employed for both systems such as described herein.

In various embodiments, the present disclosure provides a method of operating a draw lottery ticket selling and redemption system that includes: (1) a method of operating a draw lottery ticket data creation and storage system; and (2) a method of operating a draw lottery ticket data access and validation system.

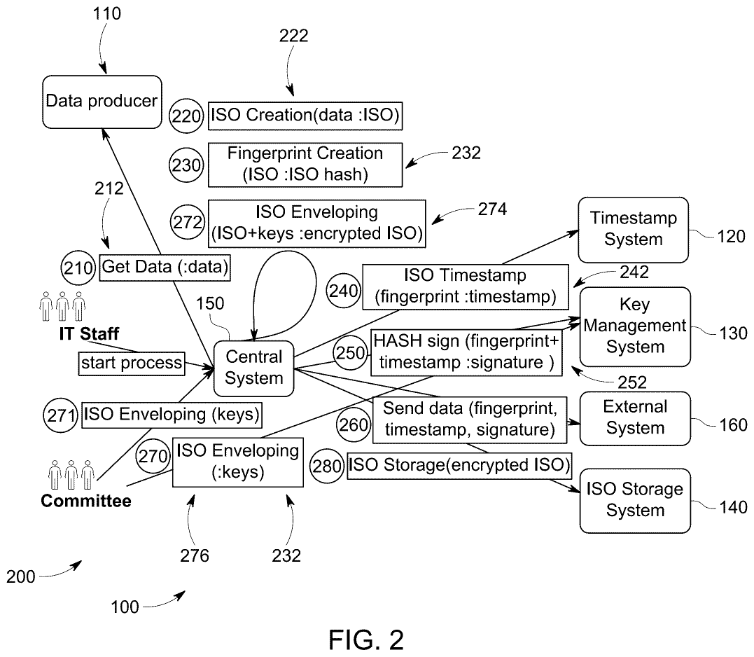

More specifically, FIG. 2 illustrates an example draw lottery ticket data creation and storage system 100 and an example method 200 of operating the draw lottery ticket data creation and storage system 100 in accordance with one example embodiment of the present disclosure.

The draw lottery ticket data creation and storage system 100 of FIG. 2 includes: (1) a data producer 110; (2) a timestamp system 120; (3) a key management system 130; (4) an ISO storage system 140; (5) a central system 150; (6) an external system 160; and (7) one or more data secure communications systems (not shown) that enable the secure communication of data between such components.

The data producer is associated with ticket transactions for the draw lottery tickets associated with a play of a draw lottery game. In various embodiments, the data producer 110 includes a central lottery server associated with the draw lottery game. In such embodiments, the data producer 110 is configured to receive and store draw lottery ticket data for each purchased draw lottery ticket for the draw lottery game. For brevity, the data for each purchased draw lottery ticket for a draw of a draw lottery game is collectively referred to herein as draw lottery ticket data 112.

In various embodiments, the draw lottery ticket data 112 includes: (1) the player numbers for the draw lottery ticket; (2) the draw lottery ticket identifier that uniquely identifies the draw lottery ticket; (3) the draw game identifier that identifies the draw lottery game; (4) the draw date for the play of the draw lottery game; (5) a print date on which the draw lottery ticket was printed; (6) bar code related data for the draw lottery ticket; and/or (7) other suitable ticket data.

In various embodiments, the data producer 110 is configured to receive the draw lottery ticket data 112 from lottery terminals, vendor point of sale devices, courier servers, and/or other suitable ticket purchase devices from which draw lottery tickets for the draw lottery game can be purchased. In various embodiments, the data producer 110 includes the ticket purchase devices themselves, that is, the lottery terminals, the vendor point of sale devices, the courier servers, and/or other suitable devices from which draw lottery tickets for the draw lottery game can be purchased. In some such embodiments, the data producer 110 generates all or a portion of the draw lottery ticket data 112.

In various embodiments, the data producer 110 includes a processor and a memory (not shown) storing instructions that, when executed by the processor, cause the processor to provide the functionality described herein. In various embodiments, the data producer 110 includes application-specific integrated circuits or other suitable hardware configured to provide the functionality described herein.

Although the data producer 110 described herein is associated with one draw lottery game and only one play of that draw lottery game for brevity, the data producer 110 can be associated with additional plays of the draw lottery game and/or additional draw lottery games in various other embodiments.

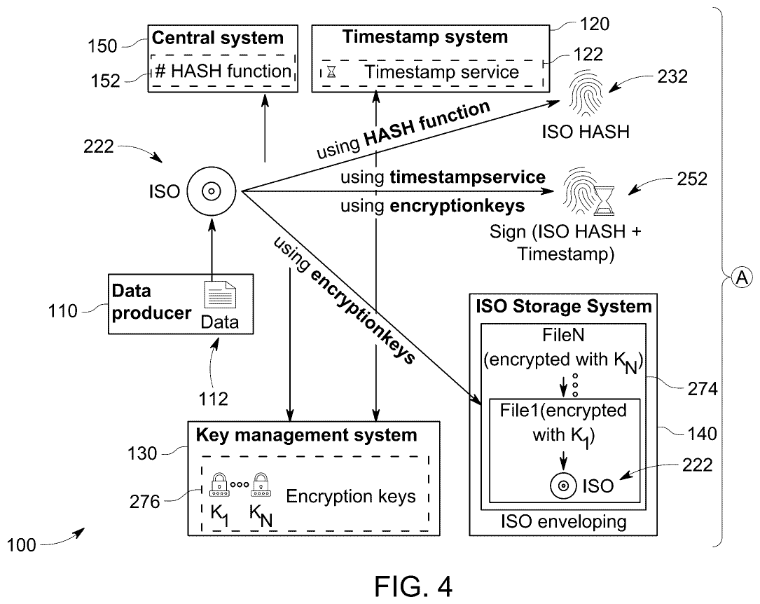

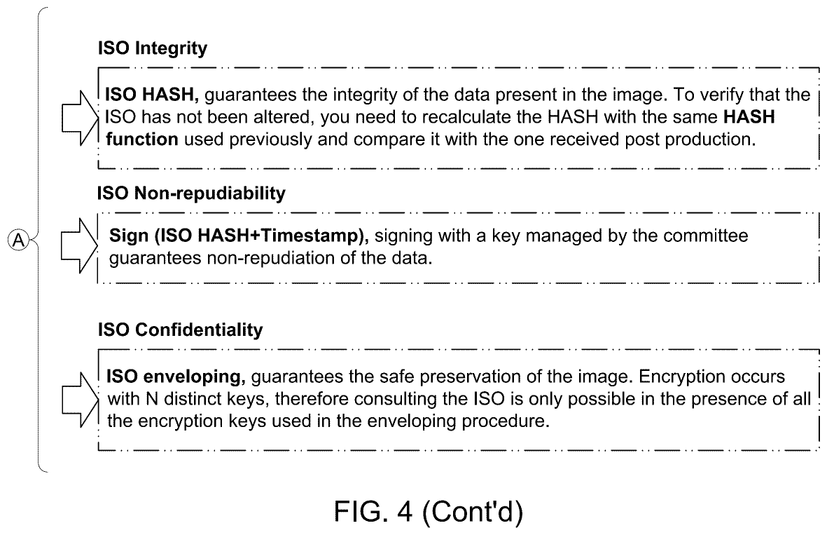

The timestamp system 120 is configured to provide a timestamp service that generates a timestamp based on a received input data. In some embodiments, the timestamp system 120 includes a timestamp service 122 (shown in FIG. 4). The timestamp includes a legally valid date and time associated with the received input data. In various embodiments, the timestamp system 120 includes a trusted third party acting as a time stamping authority. In some such embodiments, the timestamp system 120 is configured to issue a trusted timestamp employable to prove the existence of the received input data before a certain point in time. The trusted timestamp ensures that any holder of the input data (or a copy thereof), even the owner or author of the input data, cannot modify the input data and then backdate or alter the trusted timestamp. In other words, the trusted timestamp enables detection of an attempt to modify the input data to fraudulently influence the play of the draw lottery game. In various embodiments, the timestamp service is configured to provide trusted timestamping based on a public key infrastructure (PKI) architecture, a linking-based scheme, a transient key scheme, the Internet Engineering Task Force (IETF) RFC 3161 Time-Stamp Protocol, and/or other suitable timestamp protocol.

The key management system 130 is configured to securely store security keys that are employable for encryption, decryption, authentication, and/or other cryptographic functionality. In various embodiments, the security keys include files, data structures, passwords, byte strings, or other suitable security keys. In various embodiments, the key management system 130 includes a certificate authority server, registration authority server, public key infrastructure (PKI) server, or other suitable computing device that facilitates secure electronic transfer and/or storage of data. In some embodiments, the key management system 130 includes cryptographic functions and processors (e.g., standard processors, cryptographic processors) for executing the cryptographic functions. The cryptographic functions can include encryption functions, decryption functions, and/or hash functions. In various embodiments, the cryptographic functions are implemented as instructions to be executed by a processor and/or application-specific integrated circuits. In some embodiments, the key management system 130 includes authentication functions, such as user verification functions and/or digital signature functions. In various embodiments, the key management system 130 is operated by a third party operator that is different from an operator of the central system 150.

The ISO storage system 140 is configured to securely store encrypted ISOs and/or other suitable data, as described below. In various embodiments, the ISO storage system 140 includes suitable data storage devices, such as solid state drives (SSDs) and/or hard disc drives (HDDs). In some embodiments, the ISO storage system 140 includes a redundant array of inexpensive discs (RAID) configuration of the data storage devices. In some embodiments, the ISO storage system 140 includes a network attached storage device. In various embodiments, the ISO storage system 140 is operated by a third party operator that is different from an operator of the central system 150.

The central system 150 is configured to enable ISO generation and includes a computing device, such as a personal computer or server. In various embodiments, the central system 150 includes, or is associated with, a display device (e.g., an LCD monitor), a user input device (e.g., a keyboard, mouse), a user verification device (e.g., a biometric reader, image capture device), a barcode scanner, and/or other suitable input/output devices. In various embodiments, the central system 150 includes a processor and a memory (not shown) storing instructions that, when executed by the processor, cause the processor to provide and control the functionality described herein for and of the central system. In various embodiments, the central system 150 includes application-specific integrated circuits or other suitable hardware configured to provide the functionality described herein.

In various embodiments, the central system 150 is configured to provide drive imaging functions (e.g., optical disc imaging functions) for generating and/or managing ISOs (i.e., ISO images or other disc images). In the described embodiments, the central system 150 employs ISOs as the images. In other embodiments, the central system 150 employs other suitable data formats for the images, such as binary files (.bin), image files (.img), universal disc format files (.udf), and/or virtual disc images.

In various embodiments, the central system 150 is configured to provide cryptographic functions and processors (e.g., standard processors, cryptographic processors) for executing the cryptographic functions. The cryptographic functions can include encryption functions, decryption functions, and/or hash functions. In some embodiments, the central system 150 includes a hash function 152 (shown in FIG. 4). In various embodiments, the cryptographic functions are implemented as instructions to be executed by a processor and/or implemented as application-specific integrated circuits.

In various embodiments, the central system 150 is configured to provide authentication functions, such as user verification functions, digital signature functions, two factor authentication functions, and/or biometric authentication functions.

The external system 160 includes one or more computing devices, such as a personal computer, server, or distributed cloud server. In various embodiments, the external system 160 includes a secure email server, data transfer server, blockchain server, or digital ledger server. The external system 160 is separate from the central system 150 and provides improved security by storing separate copies of data, as described herein. In various embodiments, the external system 160 employs various anti-tampering measures to ensure integrity of the stored data. In some embodiments, the external system 160 is operated by a third party or lottery regulator. In other words, the external system 160 is not operated by an operator of the central system 150, an operator of a central lottery server, or a lottery operator.

In various embodiments, the data producer 110, the timestamp system 120, the key management system 130, the ISO storage system 140, the central system 150, and/or the external system 160 include or communicate via respective network interfaces (not shown) that are communicatively coupled by one or more suitable data networks (not shown). The data networks can include private networks, public networks (e.g., the Internet), wireless networks, wired networks, or other suitable data networks. The network interfaces employ the data network to transfer data, as described herein.

In the example embodiment shown in FIG. 2, the data producer 110, the timestamp system 120, the key management system 130, the ISO storage system 140, and the central system 150 are shown as separate entities. In other embodiments, two or more of the data producer 110, the timestamp system 120, the ISO storage system 140, and/or the central system 150 are combined in a same housing. In some such embodiments, the data producer 110 and the central system 150 are combined and implemented, for example, as a modified central lottery server. In some such embodiments, the central system 150 and the timestamp system 120 are combined and the central system 150 includes instructions and/or processors that implement the functionality of the timestamp system 120.

The method 200 of operating the draw lottery ticket data creation and storage system 100 of FIG. 2 includes: (210) getting data for generation of an ISO; (220) generating the ISO; (230) generating a fingerprint of the ISO; (240) getting a timestamp for the fingerprint; (250) generating a digital signature for the fingerprint and the timestamp; (260) storing the fingerprint, the timestamp, and the digital signature; (270) securely enveloping the ISO to generate an encrypted ISO; and (280) storing the encrypted ISO.

In the diagrammatic view shown in FIG. 2, inputs to an action are shown in parentheses (e.g., ISO Enveloping(keys) uses “keys” as an input) and outputs from an action are shown in parentheses and preceded by a colon (e.g., (Get Data(: data) generates “data”).

In various embodiments, the method 200 is facilitated by data managers, including users that are responsible to secure the draw lottery ticket data. In various embodiments, the data managers can include information technology (IT) staff associated with the central system 150 and/or a committee of one or more people. In this example embodiment, the committee includes three people who include regulators and two operators (that are sometimes called concessionaries). In various embodiments, the committee physically oversees the operation of the central system 150 for generation and/or storage of encrypted ISOs, fingerprints, timestamps, and/or digital signatures for a draw lottery game prior to the time the draw for that draw lottery game occurs.

In various embodiments, each member of the committee is associated with a security key that is specific to that member. The central system 150 enables each member of the committee to facilitate securing of data, such as the ISO, fingerprint, and/or timestamp. In some embodiments, the central system 150 (or another suitable entity) employs the security key as an input to a cryptographic function and/or authentication function to secure data, as described herein. In some embodiments, the central system 150 enables the use of the security key instead of the physical key for the safe that stores DVDs in the known system described above.

In various embodiments, the method 200 is started by information technology (IT) staff associated with the central system 150. For example, the IT staff employ the display device and the user input device described above to start the method 200.

The central system 150 gets the draw lottery ticket data 112 (shown as “:data”) from the data producer 110 for generation of an ISO, as indicated at block 210. For example, the central system 150 performs a data transfer of the draw lottery ticket data 112 from a central lottery server, lottery terminals, or other suitable devices. As described above, the draw lottery ticket data 112 includes the data for each purchased draw lottery ticket for a draw of a draw lottery game.

For ISO creation, the central system 150 generates an ISO 222 (shown as “:ISO”) using the draw lottery ticket data 112 (data), as indicated at block 220. In various embodiments, the central system 150 employs a drive imaging function to generate the ISO 222 to include a suitable file system and the draw lottery ticket data 112. In some embodiments, the central system 150 generates the ISO 222 to have a same data format as would be used for generating a physical DVD.

After the ISO 222 has been created, the central system 150 creates a fingerprint 232 of the ISO 222, as indicated at block 230. In various embodiments, the central system 150 employs a hash function using the ISO 222 as an input to generate an ISO hash as the fingerprint 232 (e.g., a digital fingerprint, shown as “:ISO hash”). The hash function includes a non-invertible cryptographic function that processes input data (which can have arbitrary length) and produces a data string of predefined length that is strictly related to the input data. Once the fingerprint 232 is generated from the ISO 222 and stored, data integrity of any purported copy of the ISO 222, such as a candidate ISO described below, can be verified at a subsequent time by the central system 150 (or another entity).

The central system 150 generates an ISO timestamp 242 (shown as “:timestamp”) for the ISO 222 using the fingerprint 232, as indicated at block 240. In various embodiments, the central system 150 sends the fingerprint 232 (i.e., the hash of the ISO 222) to the timestamp system 120. The timestamp system 120 employs the fingerprint 232 to generate the ISO timestamp 242 and sends the ISO timestamp 242 back to the central system 150.

The central system 150 generates a digital signature 252 (shown as “:signature”) for the fingerprint 232 and the ISO timestamp 242, as indicated at block 250. In various embodiments, the central system 150 employs an authentication function to generate the digital signature 252 using the fingerprint 232 and the ISO timestamp 242 as inputs to the authentication function. In some embodiments, the central system 150 employs a digital certificate associated with a trusted third party to generate the digital signature 252. By signing the fingerprint 232 and the ISO timestamp 242, the central system 150 ensures that the fingerprint 232 and thus the draw lottery ticket data 112 within the ISO 222 is non-repudiable. In some embodiments, the central system 150 requires a minimum quorum of the members of the committee (e.g., at least 3 out of 5) to generate the digital signature 252.

After generation of the digital signature 252, the central system 150 stores the fingerprint 232, the ISO timestamp 242, and the digital signature 252 by sending them to the external system 160, as indicated at block 260. In various embodiments, the central system 150 sends a secure email message that includes the fingerprint 232, the ISO timestamp 242, and the digital signature 252 to the external system 160. In various embodiments, the central system 150 sends the secure email message to email addresses associated with the members of the committee, a lottery operator, and/or a lottery auditor. In some embodiments, the external system 160 provides a confirmation of receipt of the secure email message.

After storing the fingerprint 232, the ISO timestamp 242, and the digital signature 252, the central system 150 generates an encrypted ISO 274. In various embodiments, the central system 150 employs security keys 276 associated with the members of the committee to generate the encrypted ISO 274 from the ISO 222.

In the embodiment shown in FIG. 2, the members of the committee provide access to the security keys 276 by each providing a separate password or other suitable user input to the key management system 130, as indicated at block 270. The key management system 130 provides the security keys 276 to the central system 150, as indicated at block 271.

The central system 150 employs an encryption function to perform an enveloping function to generate the encrypted ISO 274, as indicated at block 272. In various embodiments, the central system 150 performs the enveloping function by sequentially encrypting the ISO 222 a quantity of N times using a quantity of N distinct security keys. Using the example of three members of the committee with different security keys, N is equal to three and there are three security keys, referred to herein as K1, K2, and K3. In this example, the central system 150 encrypts the ISO 222 using the first security key K1 to generate a first encrypted intermediate file. The central system 150 then encrypts the first encrypted intermediate file using the second security key K2 to generate a second encrypted intermediate file. Next, the central system 150 encrypts the second encrypted intermediate file using the third security key K3 to generate the encrypted ISO 274.

By performing the enveloping function, the ISO 222 cannot be readily decrypted from the encrypted ISO 274 without each of the three security keys K1, K2, and K3. The central system 150 ensures confidentiality and safe preservation of the ISO 222 because accessing the ISO 222 in decrypted form is possible only by using all of the security keys, which are accessible only with the cooperation of each of the three members of the committee.

After generation of the encrypted ISO 274, the central system 150 stores the encrypted ISO 274 at the ISO storage system 140, as indicated at block 280. In various embodiments, the central system 150 transfers the encrypted ISO 274 to the ISO storage system 140 using a suitable data network.

In the example embodiment described above, the central system 150 employs a hash function to generate the fingerprint at block 230. In other embodiments, the central system 150 employs another suitable cryptographic function to generate the fingerprint, such as a security key based encryption function. In some embodiments, the central system 150 performs further processing to generate the fingerprint 232, for example, by adding a “salt” value to an output of the cryptographic function, performing one or more additional cryptographic functions on the outputs of prior cryptographic functions (e.g., a chained encryption), or other suitable processing.

In the example embodiment described above, the central system 150 employs security keys 276 stored by the key management system 130. In other embodiments, the members of the committee each insert a physical security token, such as a USB stick that includes their security key, into a suitable communication port of the central system 150 to provide the security key to the central system 150.

In some embodiments, the central system 150 employs a shared committee security key associated with the committee to generate the digital signature 252. In some such embodiments, the members of the committee collectively control access to the shared committee security key, for example, using a password, two factor authentication process, physical security token, and/or biometric security token. In some embodiments, the central system 150 interfaces with the key management system 130, which employs the security keys 276 to generate the digital signature 252. In such embodiments, the central system 150 enables each member of the committee to approve the digital signature 252 and consent to the validity of the fingerprint 232 and the ISO 222.

By employing the different security keys 276 as described above, the central system 150 enables members of the committee to facilitate the securing of the draw lottery ticket data 112 in a manner that is at least as secure as prior solutions that employed physical keys to secure the stored physical DVDs in a safe. Instead of using a physical key to lock and unlock the safe, the member(s) of the committee provides access to the security key for use with the cryptographic function and/or authentication function to secure the draw lottery ticket data 112.

In various embodiments, the draw lottery ticket data 112 contained within the encrypted ISO 274 is more secure than the physical DVD because the physical key that secures the safe containing the physical DVD can be stolen from the member and used by another person. Additionally, if the physical key is taken from the member, the physical key could then be copied by a locksmith or even by an automated key-making kiosk in a retail store enabling another person to use the copied key. Moreover, the physical locks on the safe containing the physical DVD can be physically defeated by lockpicking or drilling.

In contrast, the security key can be protected by a password known only by that member and require a conscious decision by that member to provide the password. Also in contrast, the multi-level encryption of the encrypted ISO 274 using the enveloping function and suitably complex security keys would require more processing resources and time than available before a relevant time period for providing any awards for winning lottery tickets.

Additionally, in various embodiments, the central system 150 provides a secure storage of the draw lottery ticket data 112 in less time than that used for the prior process of creating a physical DVD and storing the physical DVD. Specifically, any time related to “burning” the physical DVD by writing the ISO to the physical DVD, which can take approximately 3 minutes to 20 minutes per disc, is omitted.

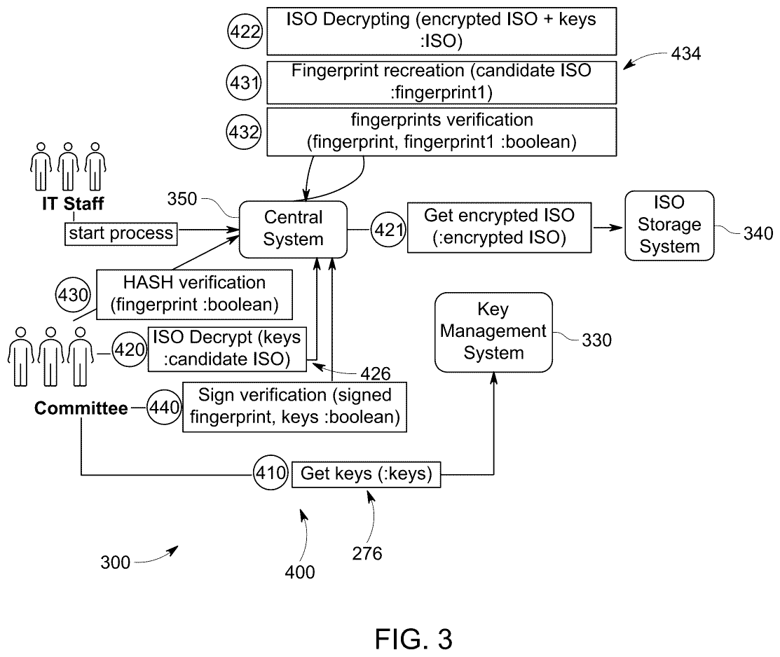

FIG. 3 illustrates an example draw lottery ticket data access and validation system 300 and an example method 400 of operating the draw lottery ticket data access and validation system 300 in accordance with one example embodiment of the present disclosure.

The draw lottery ticket data access and validation system 300 of FIG. 3 includes: (1) a key management system 330; (2) an ISO storage system 340; (3) a central system 350; and (4) one or more data secure communications systems (not shown) that enable the secure communication of data between such components.

The key management system 330 is configured to securely store security keys that are employable for encryption, decryption, authentication, and/or other cryptographic functionality. Various embodiments of the key management system 130 described above are applicable to the key management system 330. That is, the key management system 330 can include cryptographic functions, authentication functions, etc. In this embodiment, the key management system 330 and the key management system 130 described above are the same. In other embodiments, the key management server 330 and the key management server 130 are different servers. In some such embodiments, the key management server 130 includes first security keys for encryption of data and the key management server 330 includes second security keys for decryption of data previously encrypted using the first security keys.

The ISO storage system 340 is configured to securely store encrypted ISOs and/or other suitable data. Various embodiments of the ISO storage system 140 described above are applicable to the ISO storage system 340. In this embodiment, the ISO storage system 340 and the ISO storage system 140 described above are the same.

The central system 350 is configured to enable ISO validation and includes a computing device, such as a personal computer or server. Various embodiments of the central system 150 described above are applicable to the central system 350. In this embodiment, the central system 350 and the central system 150 described above are the same.

The method 400 of operating the draw lottery ticket data access and validation system 300 includes: (410) getting security keys for validation; (420) decrypting an encrypted ISO to obtain a decrypted ISO; (430) verifying a candidate fingerprint; and (440) verifying a digital signature.

In the diagrammatic view shown in FIG. 3, inputs to an action are shown in parentheses and outputs from an action are shown in parentheses and preceded by a colon.

In various embodiments, the method 400 is facilitated by IT staff associated with the central system 350 and/or a committee of people. In various embodiments, the committee physically oversees the operation of the central system 350 for verification of a stored ISO. In this embodiment, the committee of people and their associated security keys are the same as described above with respect to FIG. 2. In various embodiments, the committee remotely oversees the operation of the central system 350 for verification of the stored ISO.

In various embodiments, the method 400 is started by IT staff associated with the central system 350. For example, the IT staff employ the display device and the user input device described above to start the method 400.

The central system 350 gets the security keys 276 (“:keys”) from the key management system 330, as indicated at block 410. In the embodiment shown in FIG. 3, the members of the committee provide access to the security keys 276 by providing a password or other suitable input to the key management system 330.

The central system 350 decrypts an encrypted ISO to obtain a decrypted ISO using the security keys 276, as indicated at block 420. The central system 350 obtains the encrypted ISO, such as the encrypted ISO 274, from the ISO storage system 340, as indicated at block 421. In various embodiments, the central system 350 provides an identifier associated with the encrypted ISO 274 to the ISO storage system 340 to obtain the encrypted ISO 274. In some embodiments, the ISO storage system 340 stores the fingerprint 232 with the encrypted ISO 274 and the identifier includes the fingerprint 232.

The central system 350 employs the security keys 276 to decrypt the encrypted ISO 274, as indicated at block 422. Specifically, the central system employs each of the plurality of security keys 276 used to encrypt the encrypted ISO 274 to decrypt the encrypted ISO 274. Using the example described above, the encrypted ISO 274 is encrypted with the three security keys K1, K2, and K3 and the central system 350 decrypts the encrypted ISO 274 by first decrypting the encrypted ISO 274 using the third security key K3 to generate the second encrypted intermediate file. The central system 350 then decrypts the second encrypted intermediate file using the second security key K2 to generate the first encrypted intermediate file. Next, the central system 350 decrypts the first encrypted intermediate file using the first security key K1 to generate a decrypted ISO, referred to herein as a candidate ISO 426.

To ensure that the candidate ISO 426 is an accurate copy of the previously stored ISO 222 and has not been altered or improperly decrypted, the central system 350 verifies the candidate ISO 426 using a hash verification, as indicated at block 430. For this hash verification, the central system 350 performs a comparison of the fingerprint 232 of the ISO 222 with a candidate fingerprint to provide a Boolean value output. The Boolean value output indicates whether the fingerprints match and thus indicates whether the candidate ISO 426 matches the ISO 222 (i.e., a True value if matched, a False value if not matched).

Specifically, the central system 350 employs the candidate ISO 426 to attempt to recreate the fingerprint 232 of the ISO 222, as indicated at block 431. The recreated fingerprint is referred to herein as a candidate fingerprint 434 (shown as “fingerprint1”). The central system 350 generates the candidate fingerprint 434 using a same process as that used by the central system 150 to generate the fingerprint 232. In this example embodiment, the central system 350 employs the hash function using the candidate ISO 426 as an input to generate an ISO hash as the candidate fingerprint 434.

After generating the candidate fingerprint 434, the central system 350 performs a fingerprint verification, as indicated at block 432. In this example embodiment, the central system 350 obtains the fingerprint 232 from the external system 160. The central system 350 then performs a comparison of the fingerprint 232 and the candidate fingerprint 434 and provides a Boolean value output based on the comparison, specifically, a True value if the comparison matches or a False value if not matched. In some embodiments, the central system 350 performs a bitwise comparison of the fingerprint 232 and the candidate fingerprint 434.

If the stored fingerprint 232 and the candidate fingerprint 434 do not match, then the candidate ISO 426 cannot be verified as being an accurate copy of the ISO 222. In other words, the fingerprint 232 guarantees the integrity of the draw lottery ticket data 112 present within the ISO 222.

If the candidate fingerprint 434 matches the fingerprint 232, the central system 350 verifies the digital signature 252 for the fingerprint 232, as indicated at block 440. In this example embodiment, the central system 350 employs the security keys 276 and the candidate fingerprint 434 to generate a candidate signature. The central system 350 performs a comparison of the digital signature 252 and the candidate signature and provides a Boolean value output, specifically, a True value if the comparison matches or a False value if not matched.

If the candidate signature matches the digital signature 252, the candidate ISO 426 is verified as matching the ISO 222 and the central system 150 enables the use of the candidate ISO 426 to carry out verification and/or validation operations for draw lottery tickets (i.e., using the draw lottery ticket data 112 within the candidate ISO 426).

By employing the different security keys 276 as described above, the central system 150 enables each of the members of the committee to control access to the draw lottery ticket data 112 in a manner that is at least as secure as prior solutions that employed physical keys to store physical DVDs in a safe. Instead of using a physical key to unlock the safe, the member of the committee provides access to the security key for use with the cryptographic function and/or authentication function to decrypt the draw lottery ticket data 112. As described above, the security key cannot readily be taken or even used by another person without a conscious decision by the member.

In various embodiments, the draw lottery ticket data 112 contained within the encrypted ISO 274 is more secure than the physical DVD because the safe containing the physical DVD could be opened by copied key(s) or physically defeated by lockpicking or drilling. In contrast, the multi-level encryption of the encrypted ISO 274 using the enveloping function and suitably complex security keys would require more processing resources and time (e.g., months or years) than available before an end of a redemption time period for providing any awards for winning lottery tickets.

FIG. 4 illustrates the example draw lottery ticket data creation and storage system 100 and features generally provided by the draw lottery ticket data creation and storage system 100 in accordance with various embodiments of the present disclosure.

The data producer 110 includes the draw lottery ticket data 112.

The timestamp system 120 includes a timestamp service 122.

The key management system 130 includes the security keys 276.

The central system 150 includes a hash function 152 (“#HASH function”).

The central system 150 generates the ISO 222 from the draw lottery ticket data 112, as described above.

The central system 150 employs the ISO 222 as an input to the hash function 152 to generate the fingerprint 232 (“ISO HASH”). The fingerprint 232 guarantees the integrity of the data present in the ISO 222. To verify that the ISO 222 has not been altered, the central system 150 or another suitable entity generates the candidate fingerprint 434 with the same hash function 152 used previously for generating the fingerprint 232. In other words, the central system 150 recalculates the fingerprint 232, to ensure integrity of the ISO 222.

The central system 150 employs the fingerprint 232 and the timestamp service 522 to generate the ISO timestamp 242.

The central system 150 employs the security keys 276 to generate the digital signature 252 for the fingerprint 232 and the ISO timestamp 242. By using the security keys 276 associated with the members of the committee, the central system 150 ensures that the fingerprint 232 and thus the draw lottery ticket data 112 within the ISO 222 is non-repudiable.

The central system 150 employs the security keys 276 to generate the encrypted ISO 274 from the ISO 222 using the enveloping function, as described above. The enveloping function guarantees the safe preservation of the ISO 222. Since encryption is performed with distinct security keys for the members of the committee, the central system 150 ensures confidentiality of the ISO 222 and consulting the ISO 222 at a later time is only possible in the presence of all of the security keys used in the enveloping function.

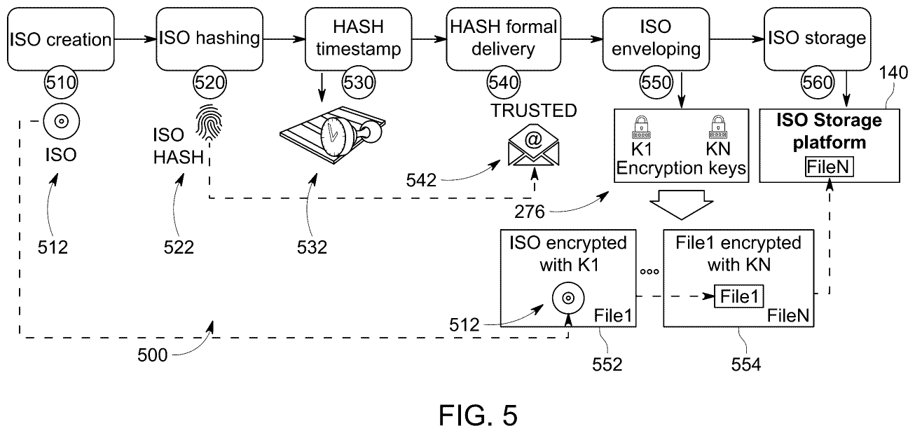

FIG. 5 illustrates an example method 500 of operating the draw lottery ticket data creation and storage system 100 in accordance with another embodiment of the present disclosure.

The method 500 of operating the draw lottery ticket data creation and storage system 100 of FIG. 2 includes: (510) ISO creation to generate an ISO; (520) ISO hashing to generate an ISO hash; (530) timestamping the ISO hash; (540) delivering the timestamped ISO hash to a trusted entity; (550) enveloping the ISO to generate an encrypted ISO; and (560) storing the encrypted ISO.

In this example embodiment, the central system 150 performs the steps of the method 500.

The central system 150 generates the ISO 512 as indicated at block 512. Specifically, the central system 150 generates the ISO 512 using draw lottery ticket data (such as draw lottery ticket data 112) as an input to a drive imaging function.

The central system 150 generates an ISO hash 522 from the ISO 512 as indicated at block 520. Specifically, the central system 150 performs the hash function 152 on the ISO 512 to generate the ISO hash 522. Data integrity of the ISO 512 (or any copy of the ISO 512) can be verified at a subsequent time by generating a candidate ISO hash and comparing with the stored ISO hash 522.

The central system 150 timestamps the ISO hash 522 to generate a timestamped ISO hash 532, as indicated at block 530. Specifically, the central system 150 provides the ISO hash 522 to the timestamp service 122 to generate the timestamped ISO hash 532.

The central system 150 generates and delivers a trusted email 542 that includes the timestamped ISO hash 532, as indicated at block 540. In various embodiments, the trusted email 542 is delivered to the external system 160, for example, to email addresses associated with the members of the committee, a lottery operator, and/or a lottery auditor.

The central system 150 envelopes the ISO 512 to generate an encrypted ISO 554, as indicated at block 550. Specifically, the central system 150 performs an enveloping function by encrypting the ISO 512 a quantity of N times using a quantity of N distinct security keys. In this example embodiment, the quantity N is two and the security keys are shown as a first security key K1 and a second security key KN. The central system 150 encrypts the ISO 512 using the first security key K1 to generate a first encrypted intermediate file 552. The central system 150 then encrypts the first encrypted intermediate file 552 using the second security key KN to generate the encrypted ISO 554.

The central system 150 stores the encrypted ISO 554 in the ISO storage platform 140, as indicated at block 560.

For subsequent data validation of the data within the ISO 512, the central system 150 decrypts the encrypted ISO 554 using the security keys in a reverse order from an order used to encrypt the ISO 512. In this example, the central system 150 decrypts the encrypted ISO 554 using the second security key KN to generate an encrypted intermediate file. The central system 150 then decrypts the encrypted intermediate file using the first security key K1 to generate a candidate ISO. The central system 150 enables data validation of the candidate ISO using the timestamped ISO hash 532 from the trusted email 542.

It should be appreciated from the above that various embodiments of the present disclosure provide a lottery ticket selling and redemption system including a central system configured to: (1) receive draw lottery ticket data for draw lottery tickets associated with a play of a draw lottery game; (2) generate a digital fingerprint based on the draw lottery ticket data; and (3) employ a plurality of separate security keys to encrypt the draw lottery ticket data with an enveloping function, wherein access to the plurality of separate security keys is controlled by a plurality of separate users and access to the draw lottery ticket data is controlled by the plurality of separate security keys, and data integrity of the draw lottery ticket data is verifiable using the digital fingerprint. In various such embodiment, the central system is configured to: (i) receive the draw lottery ticket data for the draw lottery tickets from a data producer associated with ticket transactions for the draw lottery tickets associated with the play of a draw lottery game; (ii) generate a disc image that comprises the draw lottery ticket data and to generate the digital fingerprint as a hash of the disc image; (iii) receive the plurality of separate security keys from a key management system based on separate user inputs from the plurality of separate users; (iv) perform the enveloping function by sequentially encrypting the disc image using each of the plurality of separate security keys to generate an encrypted disc image, wherein decryption of the encrypted disc image requires each of the plurality of separate security keys; (v) employ a timestamp system and the digital fingerprint to generate a digital signature for the disc image and send the digital signature to an external system, wherein data integrity of the draw lottery ticket data is verifiable using the digital signature; and (vi) store the encrypted disc image at a disc image storage system. In various such embodiment, the data producer comprises a central lottery server. In various such embodiment, the disc image is based on the International Organization for Standardization (ISO) 9660 standard. In various such embodiment, the central system is configured to sequentially encrypt the disc image using each of the plurality of separate security keys to generate the encrypted disc image by: (a) encrypting the disc image using a first security key of the plurality of separate security keys to generate a first encrypted intermediate file; (b) encrypting the first encrypted intermediate file using a second security key of the plurality of separate security keys to generate a second encrypted intermediate file; and (c) encrypting the second encrypted intermediate file using a third security key of the plurality of separate security keys to generate the encrypted disc image. In various such embodiment, the central system is configured to sequentially encrypt the disc image using each of the plurality of separate security keys to generate the encrypted disc image by encrypting the disc image a quantity of N times using a quantity of N distinct security keys of the plurality of separate security keys. In various such embodiment, the external system is operatable by a third party operator that is different from an operator of the central system. In various such embodiment, the central system is configured to: (a) generate the digital signature using a shared committee security key associated with the plurality of separate users; and (b) access to the shared committee security key is collectively controlled by the plurality of separate users. In various such embodiment, the each of the plurality of separate security keys are different from each other. In various such embodiment, the each of the plurality of separate security keys is controlled by one user of the plurality of separate users.

It should further be appreciated from the above that various embodiments of the present disclosure provide a lottery ticket selling and redemption system including a central system configured to: (1) employ a plurality of separate security keys to decrypt an encrypted disc image to generate a candidate disc image associated with draw lottery ticket data, wherein: (a) the encrypted disc image comprises an encrypted intermediate file that was encrypted with a second security key of the plurality of separate security keys, (b) the encrypted intermediate file comprises the candidate disc image that was encrypted with a first security key of the plurality of separate security keys, (c) access to the plurality of separate security keys is controlled by a plurality of separate users, and (d) access to the candidate disc image is controlled by the plurality of separate security keys; and (2) employ a first digital fingerprint of an original disc image associated with the draw lottery ticket data and a second digital fingerprint of the candidate disc image to verify data integrity of the candidate disc image. In various such embodiment, the central system is configured to: (i) receive the plurality of separate security keys from a key management system based on separate user inputs from the plurality of separate users; (ii) receive the encrypted disc image from a disc image storage system; (iii) sequentially decrypt the encrypted disc image using each of the plurality of separate security keys to generate the candidate disc image, wherein decryption of the encrypted disc image requires each of the plurality of separate security keys; (iv) generate the second digital fingerprint as a hash of the candidate disc image, wherein the first digital fingerprint comprises a hash of the original disc image; and (v) verify the data integrity of the candidate disc image if the first digital fingerprint matches the second digital fingerprint. In various such embodiment, the disc image storage system is operated by a third party operator that is different from an operator of the central system. In various such embodiment, the central system is configured to receive a digital signature from an external system, wherein the external system is operated by a third party operator that is different from an operator of the central system, and wherein the digital signature comprises the first digital fingerprint and a timestamp associated with the first digital fingerprint. In various such embodiment, the central system is configured to: (i) generate the original disc image using the draw lottery ticket data; (ii) generate the first digital fingerprint as the hash of the original disc image; (iii) timestamp the hash of the original disc image using a timestamp service; (iv) generate and send the digital signature to the external system; (v) perform an enveloping function by sequentially encrypting the original disc image using each of the plurality of separate security keys to generate the encrypted disc image, wherein decryption of the encrypted disc image requires each of the plurality of separate security keys; and (vi) store the encrypted disc image at the disc image storage system.

It should further be appreciated from the above that various embodiments of the present disclosure provide a lottery ticket selling and redemption system including a central system configured to: (1) receive draw lottery ticket data for draw lottery tickets associated with a play of a draw lottery game; (2) generate a first digital fingerprint based on the draw lottery ticket data; (3) employ a plurality of separate security keys to encrypt the draw lottery ticket data with an enveloping function to generate an encrypted disc image, wherein access to the plurality of separate security keys is controlled by a plurality of separate users and access to the draw lottery ticket data is controlled by the plurality of separate security keys, and data integrity of the draw lottery ticket data is verifiable using the first digital fingerprint; (4) sequentially decrypt the encrypted disc image using each of the plurality of separate security keys to generate a decrypted disc image; (5) generate a second digital fingerprint based on the decrypted disc image; and (6) employ the first digital fingerprint and the second digital fingerprint to verify data integrity of the decrypted disc image. In various such embodiment, the central system is configured to: generate an original disc image that comprises the draw lottery ticket data; generate the first digital fingerprint as a hash of the original disc image; and sequentially encrypt the original disc image using each of the plurality of separate security keys to generate the encrypted disc image. In various such embodiment, the central system is configured to: generate a digital signature that comprises the first digital fingerprint using a shared committee security key associated with the plurality of separate users; and access to the shared committee security key is collectively controlled by the plurality of separate users. In various such embodiment, the encrypted disc image comprises an encrypted intermediate file that was encrypted with a second security key of the plurality of separate security keys; and the encrypted intermediate file comprises the original disc image that was encrypted with a first security key of the plurality of separate security keys. In various such embodiment, the central system is configured to: after a drawing for the play of the draw lottery game, receive the plurality of separate security keys from a key management system based on separate user inputs from the plurality of separate users, and decrypt the encrypted disc image using each of the plurality of separate security keys.

Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

1. A lottery ticket selling and redemption system comprising:
a central system comprising a processor and a memory device that stores a plurality of instructions, which when executed by the processor, cause the central system to:
receive draw lottery ticket data for draw lottery tickets associated with a play of a draw lottery game;
generate a digital fingerprint based on the draw lottery ticket data; and
employ a plurality of separate security keys to encrypt the draw lottery ticket data with an enveloping function, wherein access to the plurality of separate security keys is controlled by a plurality of separate users and access to the draw lottery ticket data is controlled by the plurality of separate security keys, and data integrity of the draw lottery ticket data is verifiable using the digital fingerprint.

2. The lottery ticket selling and redemption system of claim 1, wherein the plurality of instructions, when executed by the processor, cause the central system to:
receive the draw lottery ticket data for the draw lottery tickets from a data producer associated with ticket transactions for the draw lottery tickets associated with the play of a draw lottery game;
generate a disc image that comprises the draw lottery ticket data and to generate the digital fingerprint as a hash of the disc image;
receive the plurality of separate security keys from a key management system based on separate user inputs from the plurality of separate users;
perform the enveloping function by sequentially encrypting the disc image using each of the plurality of separate security keys to generate an encrypted disc image, wherein decryption of the encrypted disc image requires each of the plurality of separate security keys;
employ a timestamp system and the digital fingerprint to generate a digital signature for the disc image and send the digital signature to an external system, wherein data integrity of the draw lottery ticket data is verifiable using the digital signature; and
store the encrypted disc image at a disc image storage system.

3. The lottery ticket selling and redemption system of claim 2, wherein the data producer comprises a central lottery server.

4. The lottery ticket selling and redemption system of claim 2, wherein the disc image is based on the International Organization for Standardization (ISO) 9660 standard.

5. The lottery ticket selling and redemption system of claim 2, wherein the plurality of instructions, when executed by the processor, cause the central system to sequentially encrypt the disc image using each of the plurality of separate security keys to generate the encrypted disc image by:
encrypting the disc image using a first security key of the plurality of separate security keys to generate a first encrypted intermediate file;
encrypting the first encrypted intermediate file using a second security key of the plurality of separate security keys to generate a second encrypted intermediate file; and
encrypting the second encrypted intermediate file using a third security key of the plurality of separate security keys to generate the encrypted disc image.

6. The lottery ticket selling and redemption system of claim 2, wherein the plurality of instructions, when executed by the processor, cause the central system to sequentially encrypt the disc image using each of the plurality of separate security keys to generate the encrypted disc image by encrypting the disc image a quantity of N times using a quantity of N distinct security keys of the plurality of separate security keys.

7. The lottery ticket selling and redemption system of claim 2, wherein the external system is operatable by a third party operator that is different from an operator of the central system.

8. The lottery ticket selling and redemption system of claim 2, wherein the plurality of instructions, when executed by the processor, cause the central system to:
generate the digital signature using a shared committee security key associated with the plurality of separate users; and
access to the shared committee security key is collectively controlled by the plurality of separate users.

9. The lottery ticket selling and redemption system of claim 1, wherein each of the plurality of separate security keys are different from each other.

10. The lottery ticket selling and redemption system of claim 9, wherein each of the plurality of separate security keys is controlled by one user of the plurality of separate users.

11. A lottery ticket selling and redemption system comprising:
a central system comprising a processor and a memory device that stores a plurality of instructions, which when executed by the processor, cause the central system to:
employ a plurality of separate security keys to decrypt an encrypted disc image to generate a candidate disc image associated with draw lottery ticket data, wherein:
the encrypted disc image comprises an encrypted intermediate file that was encrypted with a second security key of the plurality of separate security keys,
the encrypted intermediate file comprises the candidate disc image that was encrypted with a first security key of the plurality of separate security keys,
access to the plurality of separate security keys is controlled by a plurality of separate users, and
access to the candidate disc image is controlled by the plurality of separate security keys; and
employ a first digital fingerprint of an original disc image associated with the draw lottery ticket data and a second digital fingerprint of the candidate disc image to verify data integrity of the candidate disc image.

12. The lottery ticket selling and redemption system of claim 11, wherein the plurality of instructions, when executed by the processor, cause the central system to:
receive the plurality of separate security keys from a key management system based on separate user inputs from the plurality of separate users;
receive the encrypted disc image from a disc image storage system;
sequentially decrypt the encrypted disc image using each of the plurality of separate security keys to generate the candidate disc image, wherein decryption of the encrypted disc image requires each of the plurality of separate security keys;
generate the second digital fingerprint as a hash of the candidate disc image, wherein the first digital fingerprint comprises a hash of the original disc image; and
verify the data integrity of the candidate disc image if the first digital fingerprint matches the second digital fingerprint.

13. The lottery ticket selling and redemption system of claim 12, wherein the disc image storage system is operated by a third party operator that is different from an operator of the central system.

14. The lottery ticket selling and redemption system of claim 12, wherein the plurality of instructions, when executed by the processor, cause the central system to receive a digital signature from an external system, wherein the external system is operated by a third party operator that is different from an operator of the central system, and wherein the digital signature comprises the first digital fingerprint and a timestamp associated with the first digital fingerprint.

15. The lottery ticket selling and redemption system of claim 14, wherein the plurality of instructions, when executed by the processor, cause the central system to:
generate the original disc image using the draw lottery ticket data;
generate the first digital fingerprint as the hash of the original disc image;
timestamp the hash of the original disc image using a timestamp service;
generate and send the digital signature to the external system;
perform an enveloping function by sequentially encrypting the original disc image using each of the plurality of separate security keys to generate the encrypted disc image, wherein decryption of the encrypted disc image requires each of the plurality of separate security keys; and
store the encrypted disc image at the disc image storage system.

16. A lottery ticket selling and redemption system comprising:
a central system comprising a processor and a memory device that stores a plurality of instructions, which when executed by the processor, cause the central system to:
receive draw lottery ticket data for draw lottery tickets associated with a play of a draw lottery game;
generate a first digital fingerprint based on the draw lottery ticket data;
employ a plurality of separate security keys to encrypt the draw lottery ticket data with an enveloping function to generate an encrypted disc image, wherein access to the plurality of separate security keys is controlled by a plurality of separate users and access to the draw lottery ticket data is controlled by the plurality of separate security keys, and data integrity of the draw lottery ticket data is verifiable using the first digital fingerprint;
sequentially decrypt the encrypted disc image using each of the plurality of separate security keys to generate a decrypted disc image;
generate a second digital fingerprint based on the decrypted disc image; and
employ the first digital fingerprint and the second digital fingerprint to verify data integrity of the decrypted disc image.

17. The lottery ticket selling and redemption system of claim 16, wherein the plurality of instructions, when executed by the processor, cause the central system to:
generate an original disc image that comprises the draw lottery ticket data;
generate the first digital fingerprint as a hash of the original disc image; and
sequentially encrypt the original disc image using each of the plurality of separate security keys to generate the encrypted disc image.

18. The lottery ticket selling and redemption system of claim 17, wherein the plurality of instructions, when executed by the processor, cause the central system to:
generate a digital signature that comprises the first digital fingerprint using a shared committee security key associated with the plurality of separate users; and
access to the shared committee security key is collectively controlled by the plurality of separate users.

19. The lottery ticket selling and redemption system of claim 17, wherein:
the encrypted disc image comprises an encrypted intermediate file that was encrypted with a second security key of the plurality of separate security keys; and
the encrypted intermediate file comprises the original disc image that was encrypted with a first security key of the plurality of separate security keys.

20. The lottery ticket selling and redemption system of claim 17, wherein the plurality of instructions, when executed by the processor, cause the central system to, after a drawing for the play of the draw lottery game, receive the plurality of separate security keys from a key management system based on separate user inputs from the plurality of separate users, and decrypt the encrypted disc image using each of the plurality of separate security keys.
